(19) United States
(12) Patent Application Publication
(10) Pub. No.: US 2010/0326173 A1
(43) Pub. Date: Dec. 30, 2010

(54) METHOD AND APPARATUS FOR TESTING FILLED AND SEALED CONTAINERS

(75) Inventor: Morten Abrahamsen, Aros (NO)

Correspondence Address: WARN PARTNERS, P.C., PO BOX 70098, ROCHESTER HILLS, MI, 48307, US

(73) Assignee: ELOPAK SYSTEMS AG

(21) Appl. No.: 12/735,059

(22) PCT Filed: Dec. 12, 2008
(86) PCT No.: PCT/GB2008/004093

§ 371 Date: Aug. 30, 2010

(30) Foreign Application Priority Data
Dec. 14, 2007 (GB) 0724491.6

(51) Int. Cl. G01M 3/34

(52) U.S. Cl. 73/49.3

(57) ABSTRACT

A testing method comprising introducing into a pressure chamber (2) a batch of gable-top, plastics-coated paperboard cartons (10) containing a liquid, closing the chamber (2), supplying air under pressure to the interior of the chamber 2 exteriorly of the cartons (10) to a pressure level sufficient to cause the air to penetrate potential leakage paths between the outside of at least one of the cartons and the interior of the latter carton(s), whereby the air penetrates into the interior of the latter carton(s), and, after a period of time, reducing the pressure level, whereupon the air which has penetrated into the interior of the latter carton(s) causes outward bulging of the side walls of the latter carton(s).

This invention relates to a testing method and to apparatus for use in performing the same.

U.S. Pat. No. 1,590,736 discloses a method of testing filled and sealed containers, particularly cans, but also glass or other containers, in order to detect leaky containers. In the method as applied to cans, an apparatus is employed comprising an open-topped, hollow body, a cover, an inlet pipe for admitting the air under pressure to the body, a spigot valve attached to the cover and for exhausting air from within the body and a pressure gauge for indicating the pressure within the body. The body is of any suitable form and of sufficient size and capacity to contain one or any number of cans to be treated. The air inlet pipe has a valve for controlling the air input. The cover is of any suitable form and attached to the body in any suitable manner. In the embodiment shown, the cover is provided with suitable lugs and hinged to the body in companion lugs on the body. Any suitable clamping device is provided to secure the cover in position and there is shown a screw-eye pivoted in suitable lugs on the body and of sufficient length to extend over one or more projections on the cover and to receive a thumb nut. Any suitable form of gasket may be used to provide a tight seal between the cover and the body. The spigot valve has a handle to facilitate the operation thereof. The gauge is of any suitable character and may be attached to the cover or to the body.

The cans after processing (meaning heating with steam under pressure, so as to cook or sterilize) and sealing are first cooled or permitted to cool either by the application of some cooling agency or by permitting them to stand in air at atmospheric temperature. By the cooling the cans acquire a temperature substantially below that of processing, in order that the usual resulting vacuum may be created within the can. U.S. Pat. No. 1,590,736 employs the theory that, if the seams of the cans permit leakage, the cans may be caused to leak artificially and in a manner readily permitting detection of the leaks and the selection of the cans having them. The cooled cans are then placed in the body and relatively high air pressure placed upon them by first sealingly closing the cover and then pumping air into it until the desired pressure is acquired. This pressure drives the air in through the leaks by reason of the difference of the pressure without and within the cans. The period of time in which the cans are left in the closed body depends, of course, in large measure upon the extent of pressure provided. It is stated that a pressure of twenty-five pounds per square inch when sustained by the cans for a period of twelve hours gave excellent results, even when the leaks were minute and the equalization of the pressure a relatively slow action. After the cans had been subjected to the pressure for an adequate period of time, i.e. until the pressure within the cans that leaked equalled or nearly equalled the applied pressure, the pressure was relieved through the exhaust valve with more rapidity than the air could escape outward through leaks that the cans may have had. This resulted in the provision of a greater pressure within the cans that leaked than was present without them and caused their ends to bulge outwardly whereas the cans which did not leak were unaffected. Either leaky cans thus selected immediately after processing could have been treated to close the leaks or their contents could have been recovered and repackaged.

A conventional method of testing for inward leaks plastics-coated paperboard cartons with a sandwiched O₂ barrier layer is to keep the carton filled with a blue dye/alcohol mixture for at least ten minutes, but it is not reliable in many instances. Often it has been the experience that the 10 min. dye tests do not reveal small gas leakages that may spoil the product. One-hour dye tests usually reveal these small leakages but in some cases 24-hour dye tests are used to detect the fault. Gas leakage on cartons can lead to claims against the company supplying the packaging machinery and/or packaging material, and thus loss of income. A similar problem can occur with plastics bottles.

According to the present invention, there is provided a testing method comprising introducing into a pressure chamber a plurality of semi-rigid closed containers containing a substantially incompressible substance and having respective side walls comprised of plastics, closing the chamber, supplying fluid under pressure to the interior of the chamber exteriorly of the containers to a pressure level sufficient to cause said fluid to penetrate potential leakage paths between the outside of at least one of said containers and the interior of said at least one of said containers, whereby said fluid penetrates into the interior of said at least one of said containers, and, after a period of time, reducing said pressure level, whereupon said fluid which has penetrated into the interior of said at least one of said containers causes outward bulging of the side walls of said at least one of said containers.

Owing to the invention, it is possible to test filled and sealed containers, particularly plastics-coated paperboard cartons or plastics bottles, not only for potential outward leakage of liquid or gaseous substance from the interior (which testing can be performed by the per se known use of a vacuum chamber) but also for potential inward leakage of gas, particularly air, into the containers, which is important when entry of air can deleteriously affect the substance in the containers. A particular advantage is that the test can be non-destructive, so that only containers which fail the test cannot be sold.

In an embodiment of the method, a number of (for example a dozen or half-a-dozen) filled and sealed, plastics-coated paperboard cartons (or plastics bottles) are selected, particularly at random, from a production line of such cartons (or bottles) and placed in a pressure chamber, the pressure chamber is closed, compressed air is supplied to the chamber to increase the positive pressure therein to higher than 1 bar, the increased pressure in the chamber is maintained for a preset period of time, the pressure therein is reduced to atmospheric, whereupon potentially leaky cartons (or bottles) bulge outwards, the chamber is opened, and the cartons (or bottles) are removed from the chamber, the potentially leaky ones being used for research into the reasons for the potential leakage, and the others being returned to the end of the production line for shipping. We believe that the best results are obtained if the container wall zone to the tested for potential leaks bounds inwardly a head space in the container. Thus, for testing for potential leaks in a top zone, the container is upright; for testing for potential leaks in a side zone, the container is laid on its side with the side zone uppermost; and for testing for potential leaks in a bottom zone, the container is inverted. For testing for leaks into gable-topped, plastics-coated paperboard cartons filled with, say, fruit juice, we believe that good results are obtained with pressures of 1 to 4 bar for time periods of 40 to 1 minutes, especially pressures of the order of 1 to 3 bar for time periods of 15 to 1 minutes and have found that 1.5 bar for 10 minutes is particularly good for testing for leaks in gable tops. Surprisingly, for reasons presently unclear to us, we have found that higher pressures, say above 4 bar, do not lead to the same degree of detection of leaks. We have also found that, to test for leaks into bottoms of such cartons inverted, 3 bar for 30 minutes is particularly good.

Apparatus for use in performing the method according to the invention comprises a pressure chamber having an upwardly extending, outwardly opening door whereby said containers can be introduced into and removed from said chamber, a first device whereby said fluid can be supplied under pressure to said interior of said chamber, and a second device whereby said reducing of said pressure level can be carried out.

In order that the invention may be clearly and completely disclosed, reference will now be made, by way of example, to the accompanying drawings, wherein:—

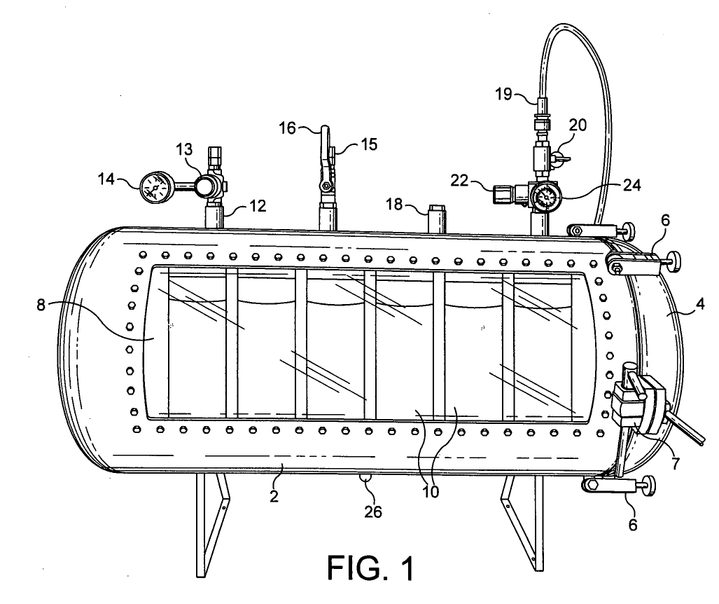

FIG. 1 is a perspective front view of a testing pressure chamber containing six conventional, gable-top, form-fill-sealed, plastics-coated paperboard cartons containing liquid food and in a closed condition;

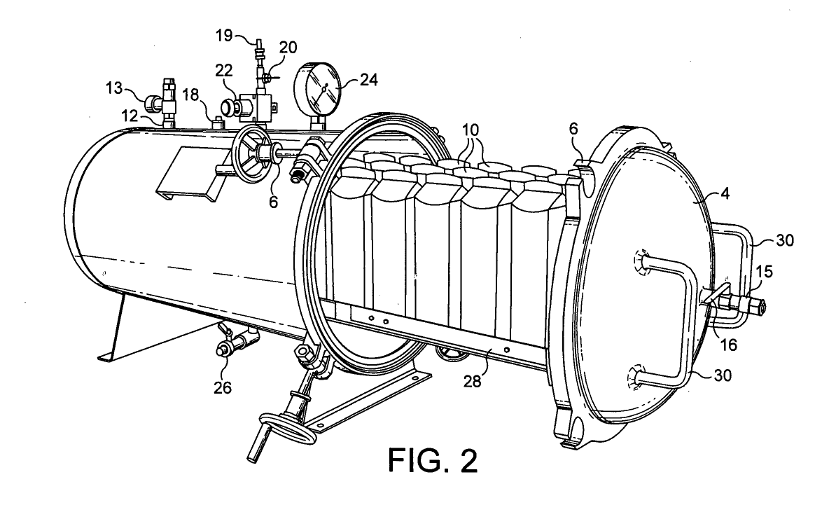

FIG. 2 is a view similar to FIG. 1, but of a modified version of the chamber containing a dozen such cartons and in an open condition'

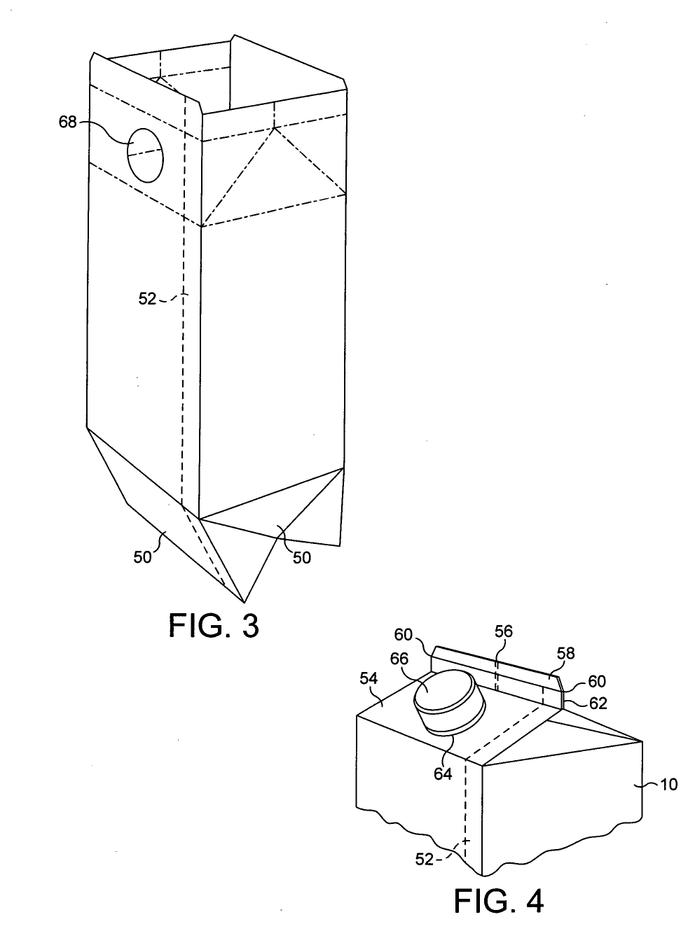

FIG. 3 is a top perspective view of such a carton during bottom-closing, and

FIG. 4 is a top perspective view of an upper part of that carton following forming, filling and sealing, and application of a pour spout fitment.

Referring to FIG. 1, the chamber 2 is horizontal and cylindrical and is sealingly closable at one end by a hinged cover 4 by the use of releasable clamps 6 between the chamber wall and the cover 4. The cover 4 is fitted with a locking mechanism 7 and a hinge (not seen) at the opposite side of the cover 4 from the mechanism 7. The wall of the chamber 2 incorporates a glass window 8 through which can be viewed the half-a-dozen gable-top cartons 10 which have been filled with liquid, for example milk or fruit juice. The cartons 10 sit upon a drawer (not shown) in the chamber 2. Each carton 10 has been formed by folding and sealing a blank consisting of a laminate comprising a paperboard substrate layer and innermost and outermost layers of a moisture barrier thermoplastics, for example low density polyethylene, possibly with a layer of oxygen barrier material, for example aluminium foil or ethylene vinyl alcohol, between the paperboard and the innermost layer of thermoplastics. The chamber 2 is fitted with a safety outlet pipe 12 containing a pressure-relief valve 13 which, with its pressure gauge 14, is provided to ensure safe operation; an outlet pipe 15 containing a pressure release valve 16 to enable the interior of the chamber 2 to be brought to atmospheric pressure before release of the clamps 6 and unlatching of the lock 7 to permit opening of the cover 4 and removal of the cartons 10; a spare outlet and/or inlet 18; and an inlet pipe 19 containing an inlet on/off valve 20 followed by an adjustable valve 22 which closes automatically when a desired pressure, indicated by its associated gauge 24, is attained in the chamber 2. The chamber 2 is also fitted with a valved drain pipe 26 whereby liquid can drain from the chamber 2 during cleaning of the chamber.

The chamber 2 is used in carton integrity testing, i.e. detection of non gas-tight cartons as follows.

A number of cartons 10, for example six cartons, is placed (in this instance upright to test for potential leaks in the gable tops) onto the opened drawer of the chamber 2, the drawer is closed to carry the cartons 10 into the chamber 2, the cover 4 is closed and compressed air is introduced through the inlet pipe 19 until the desired pressure, as indicated by the gauge 24, is attained under the control of the valve 22. The cartons are exposed to 1.5 bar for 10 minutes. The valve 20 is closed, the valve 16 is opened to release the compressed air in the chamber 2, the cover 4 is opened and the drawer is opened. Cartons with the same shape as before they were exposed to air pressure are gas-tight.

The version shown in FIG. 2 differs from that shown in FIG. 1 not only in being larger but chiefly in having the cover 4 fixed to the front of the drawer 28 so as to be slidable to-and-fro therewith. This is more convenient for the user than having the cover 4 hinged to the cylindrical wall of the chamber 2. In this version, the locking mechanism 7 and, of course, the hinge are dispensed with, whilst the cover 4 is provided with handles 30. Moreover, the outlet pipe 15 and its pressure release valve 16 are provided on the cover 4 instead of on the wall of the chamber 2. Furthermore, only one pressure gauge is provided, as seen at 24, which directly indicates the pressure in the chamber 2.

Advantageously, the control of the testing pressure level and time period is made automatic, so that the user simply operates a switch (possibly after setting a specified testing pressure value and time period value) and the apparatus itself then takes over and starts by checking that the cover 4 is closed and sealed, then allows supply of air through the valve 22 to the chamber 2 until it determines that the testing pressure is attained, and then closes the valve 22, and, after the desired time period, opens the valve 16 to allow the pressure inside the chamber 2 to be lowered to atmospheric pressure.

Referring to FIGS. 3 and 4, potential leaks may arise among the bottom closure panels 50 even when they have been fully closed and then sealed. Moreover potential leaks may arise at the side seam 52. The potential leakage problem is generally greatest in the upper end zone 54 of the carton 10, wherein, for example, there may be a potential vertical channel at 56 where generally four-ply parts of the gable top fin 58 meet, potential horizontal channels at 60 where the fin 58 changes from generally four-ply to generally two-ply, a potential leak 62 at the side seam 52, and a potential leak at the annular seal 64 between the plastics-coated, paperboard wall of the carton 10 and a flange of the pour spout fitment 66 which has been inserted outwardly through a hole 68 through the carton wall.

1-19. (canceled)

20. A testing method comprising introducing into a pressure chamber a plurality of semi-rigid closed containers containing a substantially incompressible substance and having respective walls comprised of plastics, closing the chamber, supplying fluid under pressure to the interior of the chamber exteriorly of the containers to a pressure level sufficient to cause said fluid to penetrate potential leakage paths between the outside of at least one of said containers and the interior of said at least one of said containers, whereby said fluid penetrates into the interior of said at least one of said containers, and after a period of time, reducing said pressure level, whereupon said fluid which has penetrated into the interior of said at least one of said containers causes outward bulging of the wall of said at least one of said containers.

21. A method according to claim 20, wherein said walls are respective side walls.

22. A method according to claim 20, wherein, prior to said introducing, said plurality is selected from a production line of such filled and closed containers, and, following said reducing, said chamber is opened, and said plurality of containers is removed from said chamber, the potentially leaky ones are selected from said plurality, and the others are returned to the end of the production line for shipping.

23. A method according to claim 22, wherein said potentially leaky ones selected are used for research into the reasons for the potential leakages.

24. A method according to claim 20, wherein said supplying increases positive pressure in said chamber to higher than 1 bar, and said reducing is to atmospheric pressure.

25. A method according to claim 20, wherein said potential leakage paths are in wall zones of said at least one of said containers bounding head spaces of said at least one of said containers.

26. A method according to claim 20, wherein said containers are plastics-coated paperboard cartons or plastics bottles.

27. A method according to claim 26 wherein said supplying increases positive pressure in said chamber to higher than 1 bar, and said reducing is to atmospheric pressure, wherein said potential leakage paths are in wall zones of said at least one of said containers bounding head spaces of said at least one of said containers, and wherein said containers are plastics-coated paperboard cartons and said supplying increases said positive pressure to no more than substantially 4 bar and said time period is no more than approximately two-thirds of an hour.

28. A method according to claim 27, wherein said containers are upright during testing and said supplying increases said positive pressure to no more than 2 bar and said time period is no more than one quarter of an hour approximately.

29. A method according to claim 27, wherein said containers are in an inverted condition during testing.

30. A method according to claim 20, wherein said pressure level and said time period are controlled automatically.

31. Apparatus for use in performing a method according to claim 20, comprising a pressure chamber having an upwardly extending, outwardly opening door whereby said containers can be introduced into and removed from the chamber, a first device whereby said fluid can be supplied under pressure to said chamber, and a second device whereby said pressure level can be reduced.

32. Apparatus according to claim 31, and further comprising a drawer in said chamber into which said containers can be loaded prior to testing and from which said containers can be unloaded after testing.

33. Apparatus according to claim 32, wherein said drawer is attached to said door, whereby said door moves to-and-fro with said drawer.

34. Apparatus according to claim 31, and further comprising a pressure-relief valve serving to set a maximum positive pressure attainable in said chamber.

35. Apparatus according to claim 31, wherein said first device comprises an inlet pressure regulator.

36. Apparatus according to claim 35, wherein said regulator is adjustable.

37. Apparatus according to claim 31, wherein said first device comprises an inlet on/off valve.

38. Apparatus according to claim 31, and further comprising a drain valve openable to drain liquid from the bottom of said chamber.

39. Apparatus according to claim 31 and arranged to control said pressure level and said time period automatically.
